(19) United States
(12) Patent Application Publication
(10) Pub. No.: US 2018/0036752 A1
(43) Pub. Date: Feb. 8, 2018

(54) High Velocity Spray (HVS) Dispense Arm Assemblies including a Gas Shield Nozzle

(71) Applicant: VEECO PRECISION SURFACE PROCESSING LLC, Horsham, PA (US)

(72) Inventor: William Gilbert Breingan, Media, PA (US)

(21) Appl. No.: 15/670,559

(22) Filed: Aug. 7, 2017

Related U.S. Application Data
(60) Provisional application No. 62/372,130, filed on Aug. 8, 2016.

(51) Int. Cl. B05B 7/06; B05B 7/04

(52) U.S. Cl. CPC B05B 7/06; B05B 7/0416; B05B 7/0441

(57) ABSTRACT

A high velocity spray (HVS) dispense arm assembly is configured to provide a gas shield nozzle that is arranged to dispense (blow) compressed gas out circumferentially around the HVS dispense arm to reduce or eliminate mist from contacting surfaces above the substrate being treated within process equipment.

### CROSS REFERENCE TO RELATED APPLICATION

The present application claims priority k and the benefit of U.S. patent application Ser. No. 62/372,130, filed Aug. 8, 2016, which is hereby incorporated by reference in its entirety.

### TECHNICAL FIELD

The present invention is directed to liquid process equipment for treatment of a substrate (wafer) and more specifically, to a high velocity spray (HVS) dispense arm assembly that provides a gas shield nozzle that is arranged to dispense (blow) compressed gas out circumferentially around the HVS dispense arm to reduce or eliminate mist from contacting surfaces above the substrate being treated within process equipment.

### BACKGROUND

An HVS dispense arm is used to dispense liquid process chemistry at high velocity out of a nozzle towards a wafer or other substrate. This high speed is achieved through the addition of compressed gas (typically nitrogen gas) to the chemistry at the point of dispense within the nozzle. The high speed thus achieved aids certain processes, but causes the chemistry to splash off of the wafer and form a mist within the process equipment. For reasons of cleanliness, it is desirable to keep the mist from contacting surfaces above the wafer within the process equipment. There is therefore a desire to provide a dispense arm that reduces or eliminates mist from contacting surfaces above the wafer within the process equipment.

### BRIEF DESCRIPTION OF THE DRAWING FIGURES

FIG. 1 is a perspective view of an HVS dispense arm assembly according to a first embodiment;

FIG. 2 is a cross-sectional view of the HVS dispense arm assembly of FIG. 1;

FIG. 3 is a perspective view of an HVS dispense arm assembly according to a second embodiment;

FIG. 4 is a cross-sectional view of the HVS dispense arm assembly of FIG. 3;

FIG. 5 is a perspective view of an HVS dispense arm assembly according to a third embodiment;

FIG. 6 is a cross-sectional view of an HVS dispense arm assembly of FIG. 5;

FIG. 7 is a perspective view of an HVS dispense arm assembly according to a fourth embodiment;

FIG. 8 is a cross-sectional view of an HVS dispense arm assembly of FIG. 7;

FIG. 9 is a perspective view of an HVS dispense arm assembly according to a fifth embodiment;

FIG. 10 is a cross-sectional view of an HVS dispense arm assembly of FIG. 9;

FIG. 11 is a perspective view of an HVS dispense arm according to a sixth embodiment;

FIG. 12 is a cross-sectional view of an HVS dispense arm of FIG. 11;

FIG. 13 is a perspective view of an HVS dispense arm according to a seventh embodiment; and

FIG. 14 is a cross-sectional view of the HVS dispense arm of FIG. 13.

### DETAILED DESCRIPTION OF CERTAIN EMBODIMENTS

The following description is directed to an HVS dispense arm construction. The referenced device is now described more fully with reference to the accompanying drawings, in which one or more illustrated embodiments and/or arrangements of the apparatuses and methods are shown. The apparatuses and methods are not limited in any way to the illustrated embodiments and/or arrangements as the illustrated embodiments and/or arrangements described below are merely exemplary of the present apparatuses and methods, which can be embodied in various forms as appreciated by one skilled in the art. Therefore, it is to be understood that any structural and functional details disclosed herein are not to be interpreted as limiting the present application, but rather are provided as a representative embodiment and/or arrangement for teaching one skilled in the art one or more ways to implement the present apparatuses and/or methods. Moreover, just because a certain feature is depicted in combination with a particular set of other features, no intent to so limit the invention can be inferred and each feature can be combined with any other set of other features. Accordingly, certain aspects of the present apparatuses and methods can take the form of an entirely hardware embodiment or an embodiment combining software and hardware.

In accordance with the present invention, an HVS dispense arm construction is provided and is configured such that a compressed gas, such as nitrogen, is pumped or otherwise flows through a nozzle to prevent the mist created by the HVS dispense arm from spreading above the process equipment (assembly). This mist can be referred to as being an HVS dispense that is generated from the liquid chemistry that inputted into the dispense arm. The present invention thus provides a gas shield nozzle (e.g., nitrogen shield nozzle) that is arranged to dispense (blow) compressed gas (e.g., nitrogen gas) out circumferentially around the HVS dispense arm.

First HVS Dispense Arm Assembly Construction

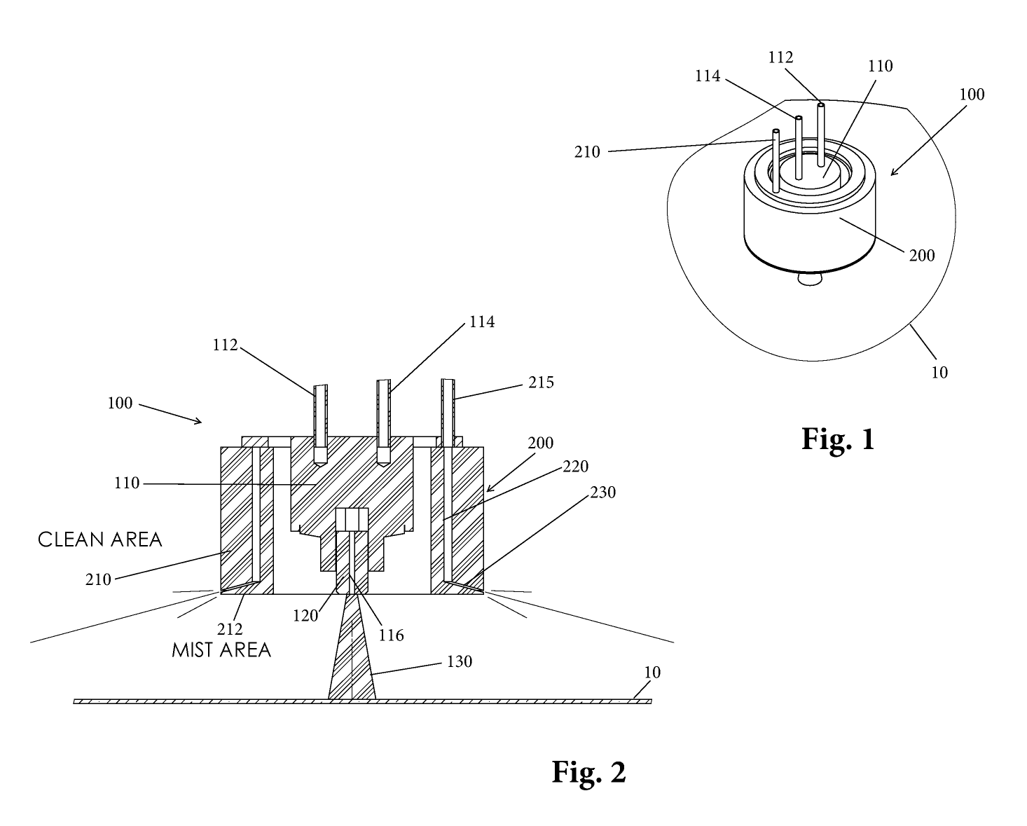

FIGS. 1 and 2 show an HVS dispense arm assembly 100 according to a first embodiment. The HVS dispense arm assembly 100 includes an HVS nozzle body 110 and an HVS nozzle 120 that is disposed at a distal end of the HVS nozzle body 110. The HVS nozzle body 110 and HVS nozzle 120 include a channel architecture to allow gas to flow therethrough. In particular, the HVS nozzle body 110 includes a first channel 112 through which HVS nozzle liquid chemistry flows and a second channel 114 through which compressed gas (e.g., nitrogen gas) flows. Conventional techniques are used to deliver the liquid chemistry to the first channel 112 and the compressed gas to the second channel 114. For example, a pump or other similar piece of equipment can be used to deliver the liquid chemistry and the compressed gas from respective sources. In other words, the conduits (lines) that deliver the liquid chemistry and the compressed gas can be connected to pumps the deliver the respective fluids to the dispense arm assembly.

The first and second channels 112, 114 are in fluid communication with a third channel 116 that is formed in the HVS nozzle 120. As shown in FIG. 2, an HVS dispense (liquid spray) 130 is discharged from the HVS nozzle 120 in a direction toward a substrate 10, such as a wafer.

The assembly 100 includes a shield gas nozzle 200 that surrounds the HVS nozzle body 110 and the HVS nozzle 120. For example, in the illustrated embodiment, the HVS nozzle body 110, the HVS nozzle 120 and the shield gas nozzle 200 are concentric with respect to one another due to the HVS nozzle body 110 and the HVS nozzle 120 having a cylindrical shape and the shield gas nozzle 200 having an annular shape (sharing a common axis).

The shield gas nozzle 200 has a body 210 with a distal end 212. The shield gas nozzle 200 has an inlet 215 for receiving compressed gas (e.g., nitrogen gas) and formed within the body 210 is a channel architecture. More specifically, the inlet 215 communicates with a first channel portion 220 that has an annular (ring) shape and at a distal end of the first channel portion 220 is a second channel portion 230 that is in fluid communication thereof. The first and second channel portions 220, 230 are continuous with respect to one another. As illustrated, the second channel portion 230 is formed at an angle and extends in a radially directed manner to an opening (exit port) that is formed along a surface of the body 210. As shown, the opening (exit port) can be formed at an interface between a bottom wall and side wall of the body 210. Based on the constructions of the shield gas nozzle 200, the flow out of the shield gas nozzle 200 is both down (i.e., the second channel portion 230 is angled down) and radially outward to form a circumferential gas flow pattern. Fluid flowing into and through this narrow portion increases fluid pressure and results in a high velocity spray being generated. As also shown, the second channel portion 230 extends radially outward.

The discharge port the second channel portion 230 lies proximate to but preferably above the discharge port of the nozzle 120.

As discussed above, the shield gas nozzle 200 is arranged to blow compressed gas (e.g., nitrogen) out circumferentially around the HVS dispense (body 110) thus generating a generally (roughly) horizontal flow regime, thereby forcing the mist out to the edges of the wafer 10 rather than allowing the mist to move upwards within the process environment.

As shown, the relative dimensions of the first and second channel portions 220, 230 can be different. For example, the dimensions of the second channel portion 230 can be less than the dimensions of the first channel portion 220 as shown. In other words, the diameter of the second channel portion 230 is less than the diameter of the first channel portion 220. However, it is within the scope of the present invention that the dimensions of the first and second channel portions 220, 230 be at least substantially the same.

In this embodiment, the shield gas nozzle 200 is a separate part from the HVS nozzle 110 which can be a commercially available air atomizing nozzle. The shield gas and the HVS gas are plumbed and controlled independently. For example, flow control equipment, such as valves and pumps, are used to control the flow of the shield gas and the HVS gas.

Second HVS Dispense Arm Assembly Construction

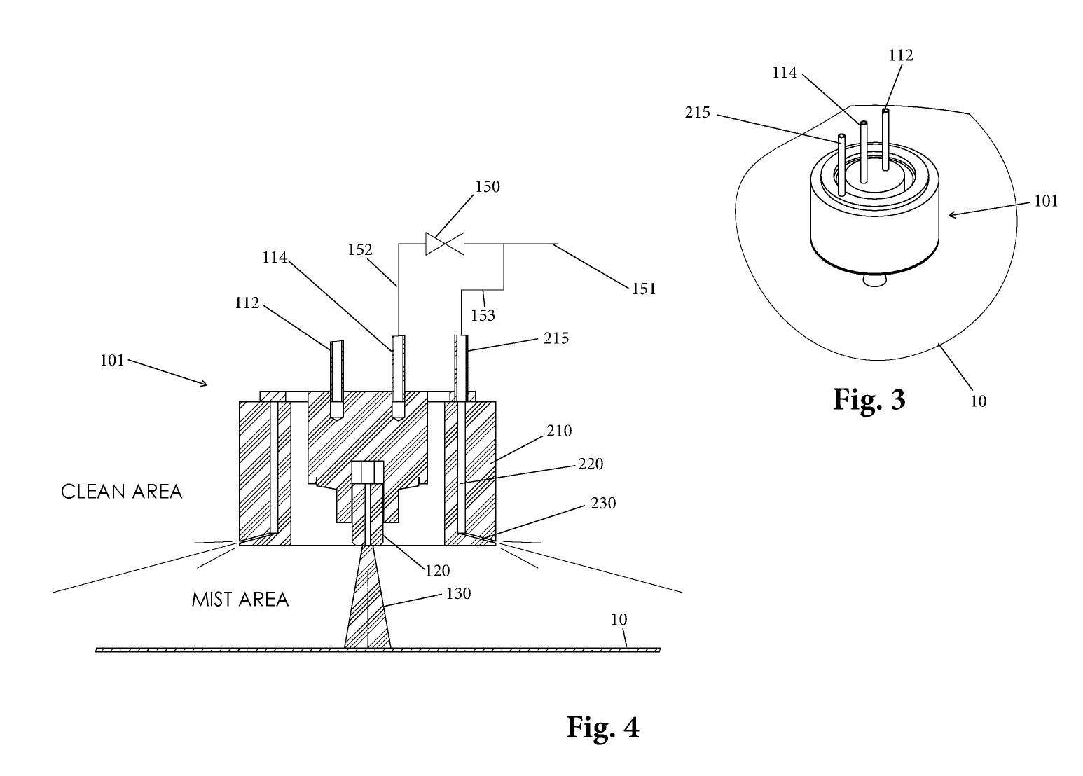

FIGS. 3 and 4 show an HVS dispense arm assembly 101 according to a second embodiment. The HVS dispense arm assembly 101 is very similar to assembly 100 and therefore, like elements are numbered alike.

In the second embodiment, the shield gas and the HVS gas are plumbed together and adjusted with a valve 150. In particular, there is a compressed gas (nitrogen gas) source 151 and a split conduit in that the compressed flows from the source 151 in a conduit that splits into a first conduit section 152 and a second conduit section 153. The first conduit section 152 is connected to the inlet 114, while the second conduit section 153 is connected to the inlet 215. Along the first conduit section 152, the valve 150 is provided to reduce the pressure or flow of the compressed gas (nitrogen) flowing into the nozzle body 110. Any number of suitable valves 150 can be used. The valve 150 is located downstream of the split of conduit sections 152, 153 but is located within the conduit section 152.

Third HVS Dispense Arm Assembly Construction

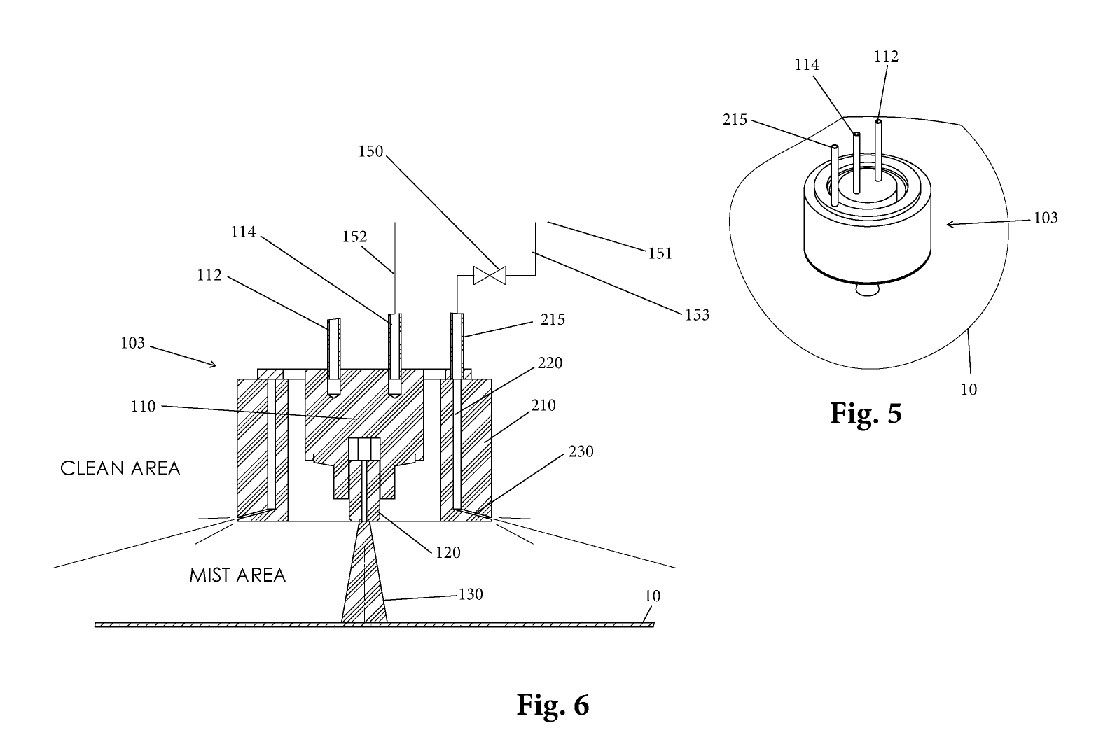

FIGS. 5 and 6 show an HVS dispense arm assembly 103 according to a third embodiment. The HVS dispense arm assembly 103 is very similar to assembly 100, 101 and therefore, like elements are numbered alike.

In the third embodiment, the location of the valve 150 is moved and repositioned along the second conduit section 153 (shield gas nozzle inlet side). Along the second conduit section 153, the valve 150 is provided to reduce the pressure or flow of the compressed gas (nitrogen) flowing into the shield gas nozzle body 210. Any number of suitable valves 150 can be used.

The valve 150 is located downstream of the split of conduit sections 152, 153 but is located within the conduit section 153.

Fourth HVS Dispense Arm Assembly Construction

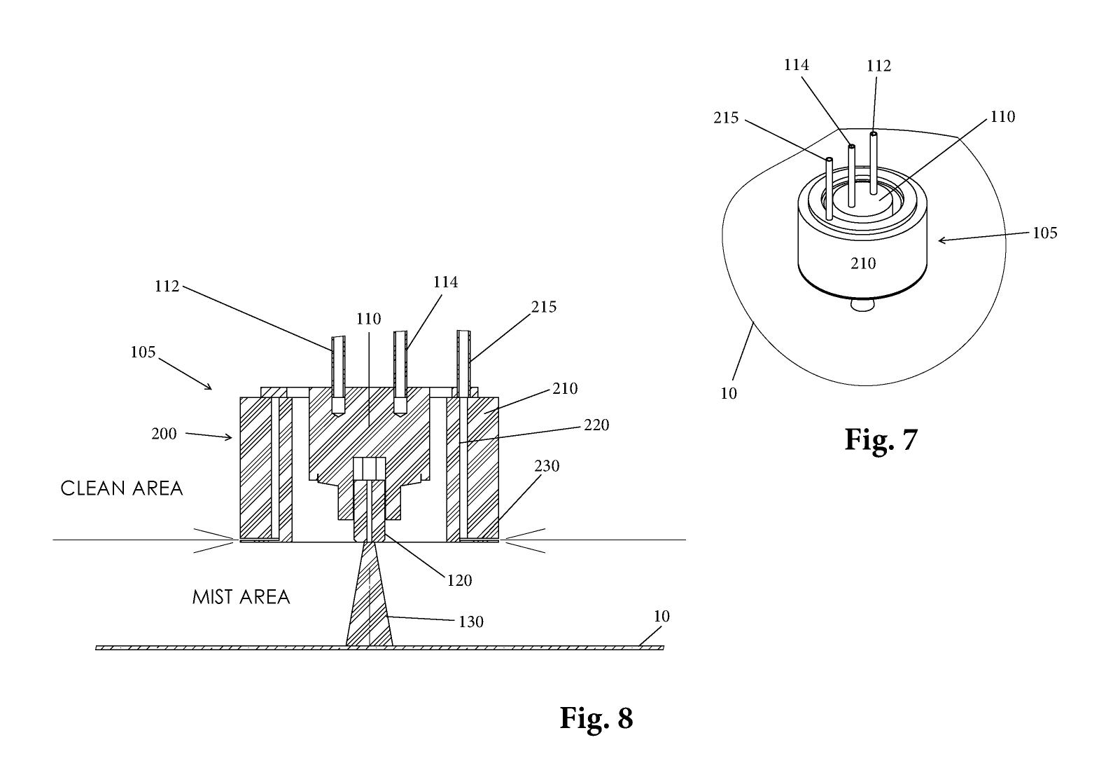

FIGS. 7 and 8 show an HVS dispense arm assembly 105 according to a fourth embodiment. The HVS dispense arm assembly 105 is very similar to assembly 100, 101 and therefore, like elements are numbered alike.

In the fourth embodiment, the second channel portion 230 is a horizontal channel. The illustrated shield gas nozzle is thus constructed such that flow out of the shield nozzle 200 (i.e., discharge from second channel portion 230) is both horizontal and radially outward.

As illustrated, there is a right angle interface between the first channel portion 220 and the second channel portion 230.

It will also be appreciated that the assembly 105 can include the split conduit and valve arrangement shown in FIGS. 3-4 or the one shown in FIGS. 5-6 to control flow of the compressed gas to the respective inlets.

Fifth HVS Dispense Arm Assembly Construction

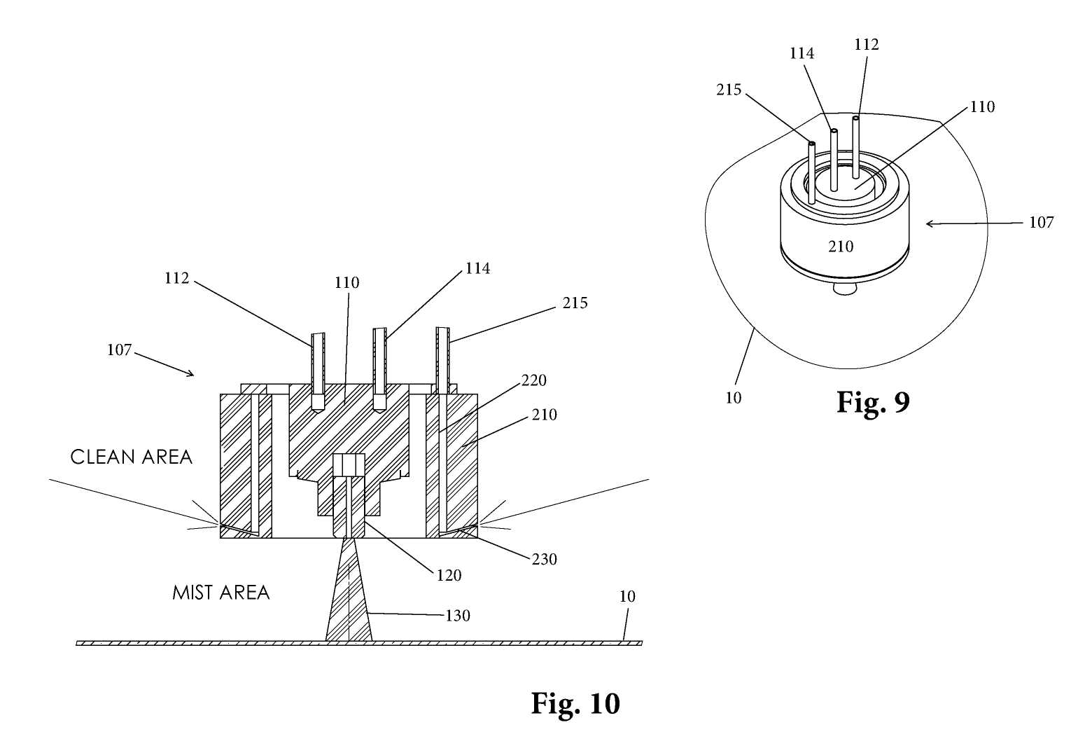

FIGS. 9 and 10 show an HVS dispense arm assembly 107 according to a fifth embodiment. The HVS dispense arm assembly 107 is very similar to assembly 100, 101 and therefore, like elements are numbered alike.

In the fifth embodiment, the second channel portion 230 is angled slightly upward relative to a bottom of the shield gas nozzle. The illustrated shield gas nozzle is thus constructed such that flow out of the shield nozzle 200 (i.e., discharge from the second channel portion 230) is both slightly up (relative to a bottom plane containing the bottom of the shield nozzle body) and radially outward.

It will also be appreciated that the assembly 107 can include the split conduit and valve arrangement shown in FIGS. 3-4 or the one shown in FIGS. 5-6 to control flow of the compressed gas to the respective inlets.

Sixth HVS Dispense Arm Assembly Construction

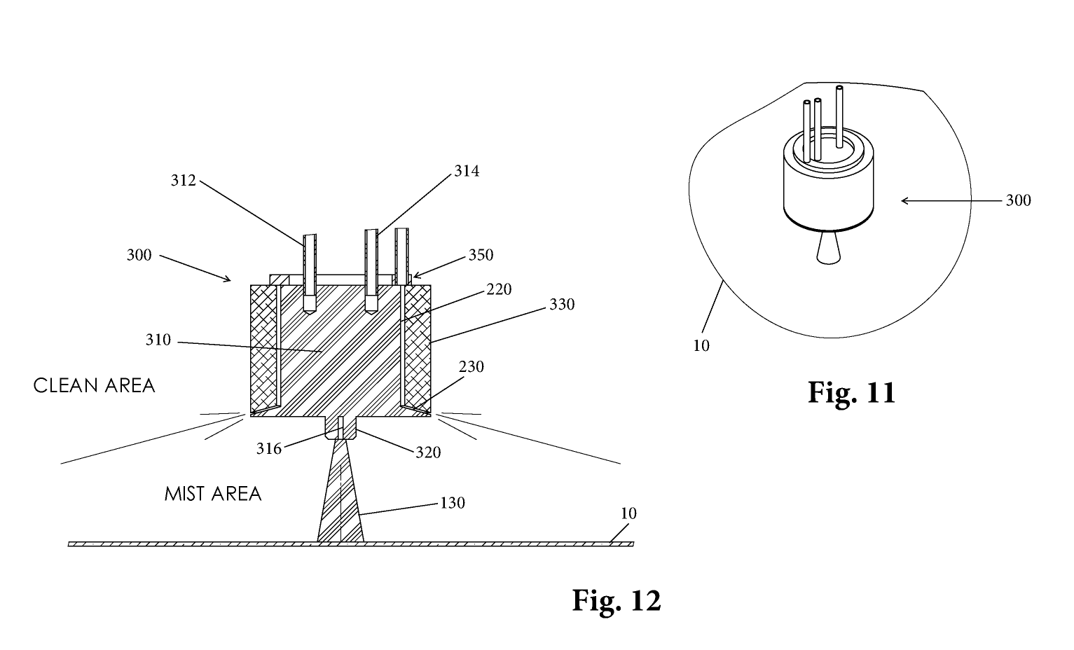

FIGS. 11 and 12 show an HVS dispense arm assembly 300 according to a sixth embodiment. The sixth embodiment shows a more integrated implementation.

The HVS dispense arm assembly 300 includes an HVS nozzle body 310 that includes a HVS nozzle 320 that is disposed at a distal end of the HVS nozzle body 310. The HVS nozzle body 310 and HVS nozzle 320 incudes a channel architecture to allow gas to flow therethrough. In particular, the HVS nozzle body 310 includes a first channel 312 through which HVS nozzle liquid chemistry flows and a second channel 314 through which compressed gas (e.g., nitrogen gas) flows. Conventional techniques are used to deliver the liquid chemistry to the first channel 312 and the compressed gas to the second channel 314. For example, a pump or other similar piece of equipment can be used to deliver the liquid chemistry and the compressed gas.

The first and second channel 312, 314 are in fluid communication with a third channel 316 that is formed in the HVS nozzle 320. As shown in FIG. 12, an HVS dispense 130 is discharged from the HVS nozzle 320 in a direction toward a substrate 10, such as a wafer.

In the assembly 300, a shield gas nozzle 350 is formed between the body 310 and an outer ring part 330. The shield gas nozzle 350 surrounds the HVS nozzle body 310. For example, in the illustrated embodiment, the HVS nozzle body 310 and the outer ring part 330 are concentric with respect to one another.

An inlet 315 for receiving compressed gas (e.g., nitrogen gas) is provided to direct the compressed gas into the shield gas nozzle 350. Similar to the first embodiment, the shield gas nozzle 350 is formed of a channel structure including a first channel portion 220 that has an annular (ring) shape and at a distal end of the first channel portion 220 (in fluid communication with inlet 315) and a second channel portion 230 that is in fluid communication thereof. The first and second channel portions 220, 230 are continuous with respect to one another. As illustrated, the second channel portion 230 is formed at an angle (downward) and extends in a radially directed manner to an opening (exit port). Based on the construction of the shield gas nozzle 350, the flow out of the shield gas nozzle 350 is both down (i.e., the second channel portion 230 is angled down) and radially outward.

As discussed above, the shield gas nozzle 350 is arranged to blow compressed gas (e.g., nitrogen) out circumferentially around the nozzle 320 thus generating a generally (roughly) horizontal flow regime, thereby forcing the mist out to the edges of the wafer 10 rather than allowing the mist to move upwards within the process environment.

As shown in FIG. 12, the distal end of the HVS nozzle body 310 has an outwardly flared end (beveled flange). Similarly, the distal end of the outer ring part 330 has a beveled edge that is complementary to the outwardly flared end of the body 310 so as to define the second channel portion 230—angled down and radially outward.

It will also be appreciated that the assembly 300 can include the split conduit and valve arrangement shown in FIGS. 3-4 or the one shown in FIGS. 5-6 to control flow of the compressed gas to the respective inlets.

Seventh HVS Dispense Arm Construction

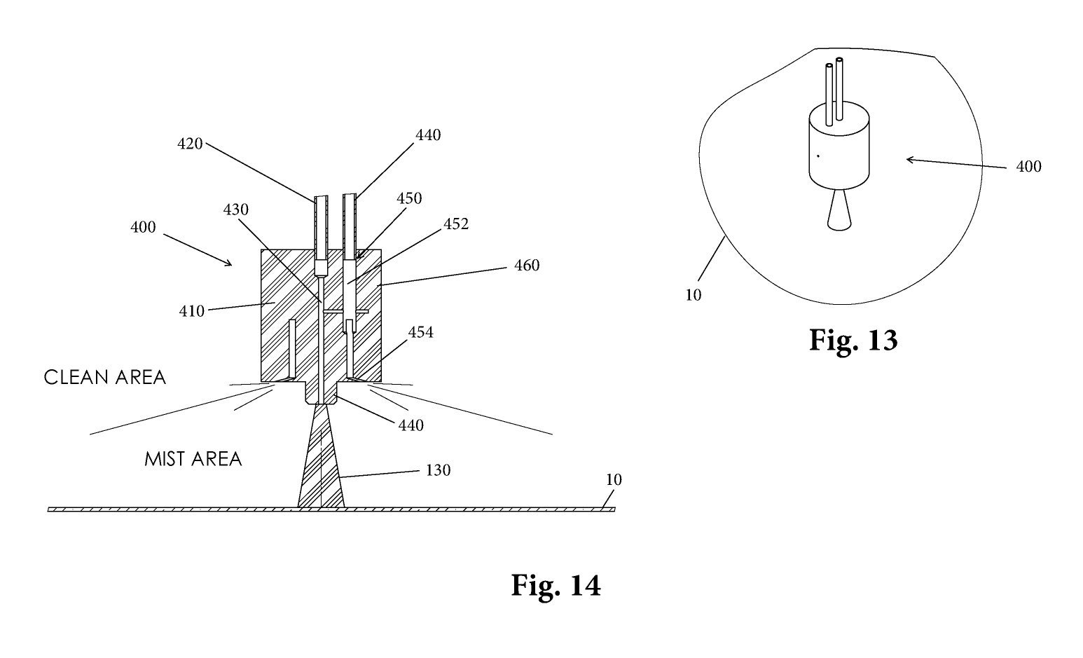

FIGS. 13 and 14 show an HVS dispense arm 400 according to a seventh embodiment. The seventh embodiment shows a more integrated implementation and more specifically, a single body includes both the shield gas nozzle and the HVS nozzle.

The HVS dispense arm 400 includes a body 410 that has an inlet 420 for the liquid chemistry (HVS nozzle liquid in) and a first channel 430 that is in fluid communication with the inlet 420. The first channel 430 terminates at a distal end in a nozzle portion 440 to discharge the HVS dispense 130.

The shield gas nozzle construction is in the form of a compressed gas inlet 440 that is in fluid communication with a shield gas channel 450. The shield gas channel 450 includes a first channel portion 452 and a second channel portion 454. The first channel portion 452 has at least a section that has an annular (ring) shape and at a distal end of the first channel portion 452, the second channel portion 454 is formed. The first and second channel portions 452, 454 are continuous with respect to one another. As illustrated, the second channel portion 454 is formed at an angle (downward angle) and extends in a radially directed manner to an opening (exit port or gas outlet). Based on the construction of the shield gas nozzle channel 450, the flow out of the shield gas nozzle 450 is both down (i.e., the second channel portion 454 is angled down) and radially outward. It will be understood that the second channel portion 454 can be formed horizontal (FIG. 8) or formed upwardly (FIG. 10).

As shown in the figure and according to one embodiment, the shield gas channel 450 has an upper portion that is in fluid communication with the inlet 440 and a lower portion that terminates in the gas outlet. As shown, the upper portion of the shield gas channel 450 can have a linear shape, while the lower portion has an annular shape. The first channel 430 is located internally within the annular shaped lower portion of the shield gas channel 450.

As also shown, the nozzle 440 is disposed below the bottom surface of the outer peripheral portion of the body 410. The outer peripheral portion has an annular shape. The second channel 450 is open along the bottom surface. The gas outlet is thus located above the HVS dispense (the shield is thus discharged above the discharge location of the HVS dispense).

The body 410 includes an internal bleed off feature 460 that fluidly connects the shield gas nozzle channel 450 and the first channel 430. The bleed off feature 460 is in the form of a channel that connects to the channels 450, 430. Thus, shield gas and HVS gas enter the nozzle together (through inlet 440) and the internal bleed off 460 allows some of this gas to feed the HVS dispense. In other words, gas flowing into the inlet 440 flows through the channel 450 and some gas flows through the bleed off channel 460 to the channel 430 in which it flows to the nozzle 440 and is discharged therefrom.

As discussed above, the shield gas nozzle 450 is arranged to blow compressed gas (e.g., nitrogen) out circumferentially around the nozzle 440 thus generating a generally (roughly) horizontal flow regime, thereby forcing the mist out to the edges of the wafer 10 rather than allowing the mist to move upwards within the process environment.

It will also be appreciated that the dispense arm assembly of the present invention is typically a part of a piece of an automated (motorized) equipment that moves the dispense arm in a controlled motion over the wafer for dispensing chemical at select locations.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A high velocity spray (HVS) dispense arm assembly comprising:
an HVS nozzle part that includes a first inlet for receiving liquid chemistry and a second inlet for receiving a compressed gas and a first nozzle outlet for discharging an HVS dispense toward a wafer; and
a shield gas nozzle that surrounds the HVS nozzle, the shield gas nozzle including a second inlet for receiving a compressed gas and a second nozzle outlet for discharging shield gas in a downward and radially outward direction so as to circumferentially surround the HVS dispense that is discharged from the first nozzle outlet.

2. The HVS dispense arm assembly of claim 1, further including: (a) a compressed gas source and a conduit fluidly connected to the compressed gas source, the conduit being branched at a first location into a first conduit section that is fluidly connected to the first inlet and a second conduit section that is fluidly connected to the second inlet, and (b) a flow control device disposed along the first conduit section downstream of the first location for reducing at least one of a pressure and flow of the compressed gas within the first conduit section.

3. The HVS dispense arm assembly of claim 1, further including: (a) a compressed gas source and a conduit fluidly connected to the compressed gas source, the conduit being branched at a first location into a first conduit section that is fluidly connected to the first inlet and a second conduit section that is fluidly connected to the second inlet, and (b) a flow control device disposed along the second conduit section downstream of the first location for reducing at least one of a pressure and flow of the compressed gas.

4. The HVS dispense arm assembly of claim 1, wherein the shield gas nozzle comprises an annular shaped body including an internal channel formed therein that terminates in the second nozzle outlet, the internal channel including a first channel section and a second channel section that terminates in the second nozzle outlet, the second channel section extending in a radially outward direction.

5. The HVS dispense arm assembly of claim 4, wherein a diameter of the second channel section is less than a diameter of the first channel section.

6. The HVS dispense arm assembly of claim 4, wherein the first channel section has an annular shape and the second channel section has a frustoconical shape.

7. The HVS dispense arm assembly of claim 4, wherein the second nozzle outlet is open along an outer surface of the annular shaped body at or proximate a bottom end thereof.

8. The HVS dispense arm assembly of claim 1, wherein the shield gas nozzle that surrounds the HVS nozzle is a separate part from the HVS nozzle.

9. A high velocity spray (HVS) dispense arm assembly comprising:
an HVS nozzle part that includes a first inlet for receiving liquid chemistry and a second inlet for receiving a compressed gas and a first nozzle outlet for discharging an HVS dispense toward a wafer; and
a shield gas nozzle that surrounds the HVS nozzle, the shield gas nozzle including a second inlet for receiving a compressed gas and a second nozzle outlet for discharging shield gas in a horizontal and radially outward direction so as to circumferential surround the HVS dispense that is discharged from the first nozzle outlet.

10. The HVS dispense arm assembly of claim 8, wherein the shield gas nozzle comprises an annular shaped body including an internal channel formed therein that terminates in the second nozzle outlet, the internal channel including a first channel section and a second channel section that terminates in the second nozzle outlet, the second channel section extending in a radially outward direction that is perpendicular to a center axis of the first nozzle outlet.

11. The HVS dispense arm assembly of claim 4, wherein a diameter of the second channel section is less than a diameter of the first channel section.

12. A high velocity spray (HVS) dispense arm assembly comprising:
an HVS nozzle part that includes a first inlet for receiving liquid chemistry and a second inlet for receiving a compressed gas and a first nozzle outlet for discharging an HVS dispense toward a wafer; and
a shield gas nozzle that surrounds the HVS nozzle, the shield gas nozzle including a second inlet for receiving a compressed gas and a second nozzle outlet for discharging shield gas in an upward and radially outward direction so as to circumferential surround the HVS dispense that is discharged from the first nozzle outlet.

13. The HVS dispense arm assembly of claim 12, wherein the shield gas nozzle comprises an annular shaped body including an internal channel formed therein that terminates in the second nozzle outlet, the internal channel including a first channel section and a second channel section that terminates in the second nozzle outlet, the second channel section extending in a radially outward direction and is oriented in an upward direction relative to a bottom of the shield gas nozzle.

14. The HVS dispense arm assembly of claim 13, wherein a diameter of the second channel section is less than a diameter of the first channel section.

15. A high velocity spray (HVS) dispense arm assembly comprising:
an HVS nozzle part that includes a first inlet for receiving liquid chemistry and a second inlet for receiving a compressed gas and a first nozzle outlet for discharging an HVS dispense toward a wafer; and
a shield gas outer ring that surrounds the HVS nozzle to define a shield gas nozzle between the HVS nozzle part and the shield gas outer ring, the shield gas nozzle including a second inlet for receiving a compressed gas and a second nozzle outlet for discharging shield gas in a downward and radially outward direction so as to circumferential surround the HVS dispense that is discharged from the first nozzle outlet.

16. The HVS dispense arm assembly of claim 15, wherein the HVS nozzle part includes an upper cylindrical portion and a bottom flange portion that is outwardly flared, the shield gas outer ring being annular shaped and having an angled bottom edge, wherein a shield gas nozzle channel comprises a gap formed between the HVS nozzle and the shield gas outer ring, the shield gas nozzle channel terminating in the second nozzle outlet.

17. The HVS dispense arm assembly of claim 16, wherein the shield gas nozzle channel includes a first channel section that is defined between an inner surface of the shield gas outer ring and a second channel section that is defined between the angled bottom edge and the bottom flange portion, the second inlet being in communication with the first channel section.

18. A high velocity spray (HVS) dispense arm comprising:
an HVS nozzle part that includes:
a first inlet for receiving liquid chemistry;
a second inlet for receiving a compressed gas;
a first nozzle channel terminating in a first nozzle outlet for discharging an HVS dispense toward a wafer, the first nozzle channel being in fluid communication with the first channel;
a shield gas nozzle channel formed in the HVS nozzle part for receiving the compressed gas from the second inlet;
a second nozzle outlet for discharging shield gas in an downward and radially outward direction; and
a bleed channel fluidly connecting the shield gas nozzle channel to the first nozzle channel for diverting a portion of the compressed gas from the shield gas nozzle channel to the first nozzle channel for feeding the HVS dispense.

19. The HVS dispense arm assembly of claim 18, wherein the HVS nozzle part has a center portion that lies below an outer peripheral portion that has an annular shape and surrounds the center portion, the first nozzle outlet being formed in the center portion, while the second nozzle outlet is formed in the outer peripheral portion and is open along an exposed bottom surface thereof.

20. The HVS dispense arm assembly of claim 18, wherein the shield gas nozzle channel and the first nozzle channel are parallel to one another and the bleed channel extends between the first nozzle channel and the shield gas nozzle.
